(19) United States
(12) Patent Application Publication
(10) Pub. No.: US 2004/0101748 A1
(43) Pub. Date: May 27, 2004

(54) Alkaline storage battery with improved casing

(76) Inventors: Rajeev Puttaiah, Troy, MI (US); Ronald Himmler, Sterling Heights, MI (US); Lin R. Higley, Troy, MI (US); Marshall D. Muller, Farmington, MI (US); Subhash K. Dhar, Bloomfield, MI (US)

Correspondence Address: ENERGY CONVERSION DEVICES, INC., 2956 WATERVIEW DRIVE, ROCHESTER HILLS, MI, 48309, US

(21) Appl. No.: 10/304,829

(22) Filed: Nov. 26, 2002

(51) Int. Cl. H01M 2/02

(52) U.S. Cl. 429/176; 106/600

(57) ABSTRACT

The present invention discloses a novel polymer alloy that may be used as a casing for alkaline storage batteries. The present invention discloses a sealed alkaline storage battery comprising a cell in which power generating elements and an alkaline electrolyte are accommodated in a battery casing of a synthetic resin. The polymer alloy comprises polyphenylene ether, polystyrene and glass fibers. The polymer alloy of the present invention comprises about 30 to 45 weight % polyphenylene ether, about 30 to 45 weight % polystyrene and about 10 to 40 weight % glass fibers. Preferably, the polymer alloy comprises 1 to 1 ratio of polyphenylene ether to polystyrene and the polystyrene is high impact polystyrene. Additionally, the polymer alloy may further include 0 to 15 weight % of an elastomer.

### FIELD OF THE INVENTION

The instant invention relates generally to improvements in rechargeable high capacity batteries, modules and packs. More particularly the present invention relates to an alkaline storage battery having a novel casing, which provides improved creep strength, good electrical isolation and improved thermal conductivity.

### BACKGROUND OF THE INVENTION

There are many known types of Ni based cells such as nickel cadmium (“NiCd”), nickel metal hydride (“Ni--MH”), nickel hydrogen, nickel zinc, and nickel iron cells. NiCd rechargeable alkaline cells are the most widely used although it appears that they will be replaced by Ni--MH cells. Compared to NiCd cells, Ni--MH cells made of synthetically engineered materials have superior performance parameters and contain no toxic elements.

Stanford R. Ovshinsky, by applying his fundamental principles of disorder, pioneered the development of the first commercial nickel metal hydride (NiMH) battery. For more than three decades, virtually every other manufacturer in the world studied the NiMH battery technology, but no commercial battery of this kind existed until after the publication of U.S. Pat. No. 4,623,597 to Ovshinsky and Ovshinsky's related technical papers which disclosed basic and fundamentally new principles of battery material design. NiMH batteries are the only truly “green” battery because they can be completely recycled. NiMH batteries are the only rechargeable battery that can meet society's requirements for an ecological, renewable source of electrochemical energy.

As previously mentioned, Stanford R. Ovshinsky was responsible for inventing new and fundamentally different electrochemical electrode materials. As predicted by Ovshinsky, detailed investigation by Ovshinsky's team determined that reliance on simple, relatively pure compounds was a major shortcoming of the prior art. Relatively pure crystalline compounds were found to have a low density of hydrogen storage sites, and the type of sites available occurred accidently and were not designed into the bulk of the material. Thus, the efficiency of the storage of hydrogen and the subsequent release of hydrogen to form water was determined to be poor. By applying his fundamental principles of disorder to electrochemical hydrogen storage, Ovshinsky drastically departed from conventional scientific thinking and created a disordered material having an ordered local environment where the entire bulk of the material was provided with catalytically active hydrogen storage sites.

Short-range, or local, order is elaborated on in U.S. Pat. No. 4,520,039 to Ovshinsky, entitled Compositionally Varied Materials and Method for Synthesizing the Materials, the contents of which are incorporated by reference. This patent discusses how disordered materials do not require any periodic local order and how, by using Ovshinsky's techniques, spatial and orientational placement of similar or dissimilar atoms or groups of atoms is possible with such increased precision and control of the local configurations that it is possible to produce qualitatively new phenomena. In addition, this patent discusses that the atoms used need not be restricted to “d band” or “f band” atoms, but can be any atom in which the controlled aspects of the interaction with the local environment and/or orbital overlap plays a significant role physically, electronically, or chemically so as to affect physical properties and hence the functions of the materials. Ovshinsky's use of disordered materials has fundamental scientific advantages. The elements of these materials offer a variety of bonding possibilities due to the multidirectionality of d-orbitals. The multidirectionality (“porcupine effect”) of d-orbitals provides for a tremendous increase in density and hence active storage sites. These techniques result in means of synthesizing new materials which are disordered in several different senses simultaneously.

Sealed alkaline storage batteries, which typically include nickel-cadmium storage batteries and nickel-metal hydride storage batteries, are widely used as power sources for portable apparatuses such as a video tape recorder, a laptop computer and a portable telephone owing to their high energy density and reliability. Each cell of these batteries has a metal casing of a cylindrical or rectangular shape, and is a small-sized sealed alkaline storage battery of which capacity is about 0.5 to 3 Ah. In practical applications, several or several tens of cells are usually accommodated in a synthetic resin casing or tube.

These small-sized sealed alkaline storage batteries have a battery capacity as small as about 0.5 to 3 Ah, and hence respectively generate only a small amount of heat during a charging or discharging period.

Therefore, even in case of using such batteries in casing or tube, an appropriate balance has been established between heat generation and heat radiation. Consequently, no significant problem has arisen with regard to the temperature rise of the battery. The electrodes of the alkaline storage battery expand as a result of repetitive charging and discharging processes. Since the casing is made of a metal and has a cylindrical shape, the expansion of the electrodes does not produce a serious problem such as deformation of the casing. Even in the case where the casing has a rectangular shape, casing or the like does not need special design, since the battery is small in size.

However, recently there is a strong demand for medium and large-sized batteries (--a medium-sized battery is defined as that having a capacity of 10 to 100 Ah, a large-sized battery as that having a capacity of above 100 Ah; and the number of cells used in the battery ranges from several to several hundreds for either type--), which have a high energy density and reliability, as a mobile power source for various apparatuses ranging from a home-use appliance to an electric vehicle. Such medium and large-sized batteries, for example, an open-type nickel-cadmium storage battery and a lead-acid storage battery are used for energy storage, an uninterruptible power source, etc. However, these batteries have a disadvantage of the need of troublesome maintenance such as the addition of an electrolyte solution during the lifetime. When a battery is to be used as a mobile power source for various apparatuses ranging from a home-use appliance to an electric vehicle, therefore, the battery is required to be maintenance-free or have a sealed configuration.

As described above, in the case where an alkaline storage battery is used as a mobile power source for various apparatuses ranging from a home-use appliance to an electric vehicle, the battery is required to attain both a sealed configuration and an increase of the capacity to the medium or large size. More specifically, in order to increase the capacity and voltage of a module battery, it is necessary to connect a large number of cells in series besides sealing the cells.

A battery generates reaction heat and Joule's heat due to the electrode reaction during charging and discharging processes. The increased capacity with sealed configuration of a battery causes increase of the amount of generated heat. As the result, heat radiation to the outside of the battery is retarded, and the generated heat is accumulated within the battery. Consequently, the internal temperature of such a battery is higher than that of a small-sized battery. In a module battery consisting of a series connection of such large capacity cells, or a pack battery consisting of a series connection of module batteries, several tens to several hundreds of cells are arranged in a contiguous manner. Therefore, the retardation of heat radiation is further enhanced so that the temperature in the battery is further raised.

In order to solve the problems, Japanese Laid-Open Patent Publication No. Hei 3-291867 proposes an air circulation type heat radiation means for a storage battery system which has a large number of cells each consisting of positive and negative electrodes and an electrolyte and generating heat during a charging process In the proposed air circulation type heat radiation means, a space for allowing air to flow therethrough is formed between the cells, and a ratio of the space width to the cell width is set to a range of 0.1 to 1.0.

Similarly to the casing of a conventional lead-acid storage battery for use in an automobile, and in view of a reduced weight, the casing of such a battery for a mobile power source is made of a synthetic resin which mainly contains polypropylene.

When a casing made of polypropylene is used in an alkaline storage battery for a relatively large capacity mobile power source as described above, there arise the following problems:

(1) In a lead-acid storage battery, even when it is of the sealed type, the internal pressure due to charging rises to only about 0.05 MPa. In contrast, in a sealed alkaline storage battery, the internal pressure rise during the charging process reaches such high pressure as 0.2 to 0.4 MPa. In the case where a battery is used outdoors as a mobile power source under a high temperature environment for a long term, particularly when the battery is used or left in a charged condition, the casing of the battery is kept receiving an internal pressure of about 0.2 to 0.4 MPa or more. In such a case, a battery casing made of polypropylene has a danger of breakage due to creep deformation. In the case where charging and discharging cycles are repeated 1,000 or more times under a outdoor high temperature environment, a battery casing made of polypropylene has a danger of breakage due to mechanical fatigue caused by the internal pressure change, and hence such a casing is not sufficient in long-term reliability and safety.

(2) A battery casing made of polypropylene is expanded by the internal pressure rise of the battery due to repetitive charging and discharging processes, because the power generating elements expand. This expansion reduces the width of the space for air flow, whereby the heat radiation efficiency of the battery is largely lowered so that the performances of the battery such as the cycle life are impaired. In order to maintain the space between cells constant, the mechanical strength of the battery casing must be increased. To increase the strength of a casing, it is necessary to increase thickness of the casing at the expense of increased weight and volume of the casing. Thereby, the weight and volume of the battery are increased and hence the energy density of the battery is lowered.

(3) In the case where the battery casing is expanded and deformed by the internal pressure rise of the battery, a space is formed between the power generating elements and the battery casing. The generation of the space between the power generating elements and the battery casing causes great decrease of the rate of transmission of heat generated in the power generating elements to the battery casing. Accordingly, it is required to keep the battery casing in contact with the power generating elements.

(4) In an application to a mobile power source, a module battery consisting of 5 to 40 stacked cells, or a pack battery consisting of 2 or more module batteries or equivalent to a set of about 10 to 300 cells is used in general. Under such configuration, variations or inuniformities of battery performances such as the capacity must be decreased, and improvement of battery performances such as the energy density must be attained. For using a battery in an automobile, such consideration and countermeasures must be particularly taken as preventing displacement due to vibrations, improving impact resistance and providing incombustibility, in view of a collision accident. Furthermore, consideration must be made against stress corrosion crack due to deposition of machine oil and the like in the assembly line or during maintenance.

U.S. Pat. No. 5,817,435 issued to Shimakawa et al. on Oct. 6, 1998 discloses a casing of sealed alkaline storage battery to be stacked in plural number in one direction, each provided with a safety vent; each casing is made of a polymer alloy which mainly comprises polyphenylene ether, polystyrene and an elastomer; at least one outersurface of the casing has a plurality of vertical protrusion ribs thereby to form vertical ventilation spaces through which a cooling medium passes. However, the '435 does not incorporate the use of glass fibers to achieve the superior performance of the instant invention.

U.S. Pat. No. 6,071,643 issued to Chino et al. on Jun. 6, 2000 discloses a material comprising specific amounts of a resin composition which comprises a styrenic polymer having the syndiotactic configuration, a polyolefin or a styrenic elastomer, and a polyphenylene ether which is used optionally, or a material comprising a resin composition which comprises specific amounts of a resin component having the same composition as the above resin composition, an inorganic filler, and a polyphenylene ether modified with a polar group which is used optionally. Additionally, the '643 patent discloses an embodiment wherein the inorganic filler is glass fiber. However, the compositions differ from those disclosed in the present invention. Also, the present invention incorporates in specific percentages outside the scope of the '643 patent.

### SUMMARY OF THE INVENTION

The present invention discloses a novel polymer alloy that may be used as a casing for alkaline storage batteries. The polymer alloy of the present invention comprises about 30 to 45 weight % polyphenylene ether, about 30 to 45 weight % polystyrene and about 10 to 40 weight % glass fibers. Preferably, the polymer alloy comprises 1 to 1 ratio of polyphenylene ether to polystyrene and the polystyrene is high impact polystyrene. Additionally, the polymer alloy may further include 0 to 15 weight % of an elastomer.

The addition of glass fibers provides the PPE/PS alloy with improved creep strength, good electrical isolation and improved the thermal conductivity. The glass fibers have a diameter of from 3.75×10⁻⁴ inches to 1.00×10⁻³ inches.

The present invention discloses a sealed alkaline storage battery comprising a cell in which power generating elements and an alkaline electrolyte are accommodated in a battery casing of a synthetic resin. The casing is a polymer alloy. The polymer alloy comprises about 30 to 45 weight % polyphenylene ether, about 30 to 45 weight % polystyrene and about 10 to 40 weight % glass fibers.

The present invention discloses a sealed alkaline storage battery comprising a cell in which power generating elements and an alkaline electrolyte are accommodated in a battery casing of a synthetic resin. The casing is a polymer alloy which comprises polyphenylene ether, polystyrene and about 10 to 40 weight % glass fibers.

### BRIEF DESCRIPTION OF THE DRAWINGS

FIG. 1 is a three-dimensional view of an exemplary monoblock battery case that may utilize the polymer alloy compositions of the present invention.

### DETAILED DESCRIPTION OF THE INVENTION

PPE has alkali resistance, and exhibits excellent mechanical strength in a wide range from a low temperature to a high temperature. Particularly, PPE is excellent in rigidity (bending elastic modulus), impact resistance (Izod impact resistance), and creep characteristics. PPE has a heat distortion temperature of about 170° C. to 180° C. under the standards described later, and a glass transition temperature of about 220° C.

Although PPE has excellent features as described above, PPE has low flow properties, and hence is poor in moldability, so that a residual strain remains after molding resulting in a high proportion defective in the process of molding a battery casing. Therefore, PPE alone is not suitable for a practical use.

On the other hand, PS has alkali resistance and is excellent in moldability. For example, PS has a mold shrinkage factor of about 0.3 to 0.6%, and a melt flow rate (hereinafter referred to “MFR”) of about 15 to 30 g/(10 min.). Although PS has a sufficient rigidity at ordinary temperature, PS has a heat distortion temperature as low as about 80° C., so that the bending elastic modulus at about 70° C. is no more than 1,000 MPa or PS is insufficient in rigidity. Furthermore, PS has a glass transition temperature of about 100° C. and an Izod impact value of 100 J/m, or is poor in impact resistance.

In contrast, a polymer alloy of PPE and PS is more excellent in moldability than PPE alone, so that a production process using injection molding is easily conducted. The MFR of the polymer alloy can be improved to 10 to 15 g/(10 min.) at 300° C.

In a preferred embodiment, PS is high impact polystyrene (HIPS). The HIPS of a preferred embodiment of the present invention is a genus of rubber-modified polystyrenes comprising blends and grafts. The rubber is a polybutadiene or a rubbery copolymer of about 70-98% styrene and 2-30% diene monomer. PS is strong but brittle by itself, so the addition of polybutadiene provides an improved durability of HIPS over PS.

PPE by itself is hard to mold and process. HIPS is alloyed with PPE to make it flow better and process easier. In addition, it may be alloyed at different proportions. This is called a modified PPE resin. The alloy thus formed is a different plastic altogether in that it has only one melting temperature. Glass fibers are then added to the alloy to provide all of the necessary properties such as improved creep strength, isolation resistance, thermal conductivity, and low part shrinkage.

The heat distortion temperature of the polymer alloy is high or about 120° C. as compared with that of PS alone. Therefore, the polymer alloy exhibits superior mechanical strength also at a higher temperature and has a bending elastic modulus of about 1,700 to 2,000 MPa at about 80° C. Furthermore, the Izod impact value is improved to about 200 J/m. Regarding creep characteristics, when the tensile stress in a tensile creep test according to JIS (Japanese Industrial Standards) K-7115 is 10 MPa, the creep strain after 1,000 hours is 2% or less. JIS K-7115 is almost corresponding to ISO (International Standard) 899.

When the battery is to be used as a mobile power source such as an application in an automobile, addition of an elastomer in a range of 15 wt % or less may be added. The addition of an elastomer improves the Izod impact value to about 300 J/m at the maximum, whereby impact resistance can be improved. The elastomer may be selected from, but not limited to, styrene-butadiene rubber, butadiene rubber and ethylenepropylene terpolymer.

The addition of glass fibers improves creep strength, shrinkage, dimensional stability, thermal conductivity and electrical isolation properties. The polymer alloy of the present invention comprises about 30 to 45 weight % PPE, about 30 to 45 weight % PS and about 10 to 40 weight % glass fibers. Preferably, the composition of the PPE and HIPS is in a ratio of 1 to 1 and the glass content of the alloy may be in the range of from 10 to 40 weight %. For example, with 20% glass fiber the composition would be 40% PPE/40% HIPS/20% glass fiber.

The glass fibers used in this alloy are short glass fibers. The dimensions of the glass fibers may range from 37.5×10⁻⁴ inches to 100×10⁻³ inches in diameter.

Properties of the Plastic:

Creep strength is very important in alkaline storage batteries due to the expansion of the electrode throughout the life of the battery. The addition of glass improves the creep strength of the parent material without sacrificing its properties. This attribute is especially noticeable in liquid cooled batteries such as the OVONIC® X20 and OVONIC® 42V battery systems. At this time, no device or method exists to internally reinforce the cooling channels that are located on the inside of the battery. As a result, the plastic material in the casing has to support itself internally under creep. From Table I, the addition of glass makes the resulting material about 10 times more resistant to creep for a given load.

TABLE I

| Plastic Material/ | Sample | O Hrs | 300 Hrs | 600 Hrs |
|---|---|---|---|---|
| Creep Modulus | No. | (psi) | (psi) | (psi) |
| PPE (no glass) | 1 | 1.6E+05 | 5.0E+04 | 4.0E+04 |
| PPE (no glass) | 2 | 2.0E+05 | 8.0E+04 | 7.5E+04 |
| PPE w/30% glass | 3 | 1.0E+06 | 7.5E+05 | 7.0E+05 |

Electrical isolation is very critical in batteries due to the large voltages that can be used. Glass fibers provide good mechanical strength, reduce creep significantly and improve electrical isolation resistance. Experiments were done to measure the electrical isolation effectiveness of the glass fiber, as detailed in Table 2 below. From Table II, the samples with glass fill start out having several orders of magnitude higher isolation resistance than the ones without any glass. Also, over accelerated life tests the samples without glass degraded over time and were deemed unacceptable whereas the glass filled samples remained relatively unchanged. The creep properties and electrical isolation properties are interrelated in that increase in creep of the plastic results in decreased electrical isolation resistance.

TABLE II

| | | | | 7 days at |
|---|---|---|---|---|
| | | 26° C. | 35° C. | 62° C. |
| Plastic Module | Sample No. | (Ohms) | (Ohms) | (Ohms) |
| PPE without glass fiber | 1 | 9E+07 | 5E+07 | 3E+06 |
| (12 V module) | | | | |
| PPE without glass fiber | 2 | 9E+07 | 4E+07 | 4E+06 |
| (12 V module) | | | | |
| PPE without glass fiber | 3 | 8E+07 | 4E+07 | 4E+06 |
| (12 V module) | | | | |
| PPE with 30% glass fiber | 4 | 20E+10 | 5E+10 | 7E+10 |
| (12 V module) | | | | |
| PPE with 30% glass fiber | 5 | 18E+10 | 4E+10 | 5E+10 |
| (12 V module) | | | | |
| PPE with 30% glass fiber | 6 | 18E+10 | 3E+10 | 3E+10 |
| (12 V module) | | | | |
| PPE with 30% glass fiber | 7 | 21E+10 | 3E+10 | 5E+10 |
| (12 V module) | | | | |
| PPE with 30% glass fiber | 8 | 25E+10 | 4E+10 | 6E+10 |
| (12 V module) | | | | |

Thermal management is important for alkaline storage batteries. The addition of glass fibers improves the thermal conductivity of the plastic. This is particularly beneficial for air/liquid-cooled batteries that operate at very high current loads.

The application of polymer alloys of the present invention allows a relatively large capacity sealed alkaline storage battery to be configured which is practically useful and in which the side walls in the stacking direction of the casing of a module battery have a thickness of 2 to 4 mm, depending on whether it is a HEV, EV or 42V system. These batteries and others operate at up to 120-psi internal pressure, which is quite demanding on the construction material of the casing. Also, some batteries have internal liquid cooling which is even more demanding on the construction material of the casing since it is not possible to reinforce internal channels with metal restraints. The casing described in the present invention permits the batteries to withstand this type of pressure and stress.

According to the sealed alkaline storage battery of the invention, the mechanical strength of the battery casing is improved so that the breakage due to creep deformation or mechanical fatigue caused by an internal pressure variation owing to repetitive charging and discharging processes conducted outdoors and under a high temperature environment is prevented from occurring. Accordingly, long-term reliability and safety can be enhanced.

The improvement of the mechanical strength can prevent the battery casing from being expanded or deformed by the internal pressure rise during the charging process or the expansion of the electrode group. The heat generated in the battery during charging and discharging processes can efficiently be dissipated to the outside of the battery through the battery casing. Consequently, the variation in the state of charge of the cells is reduced and the cycle life is improved.

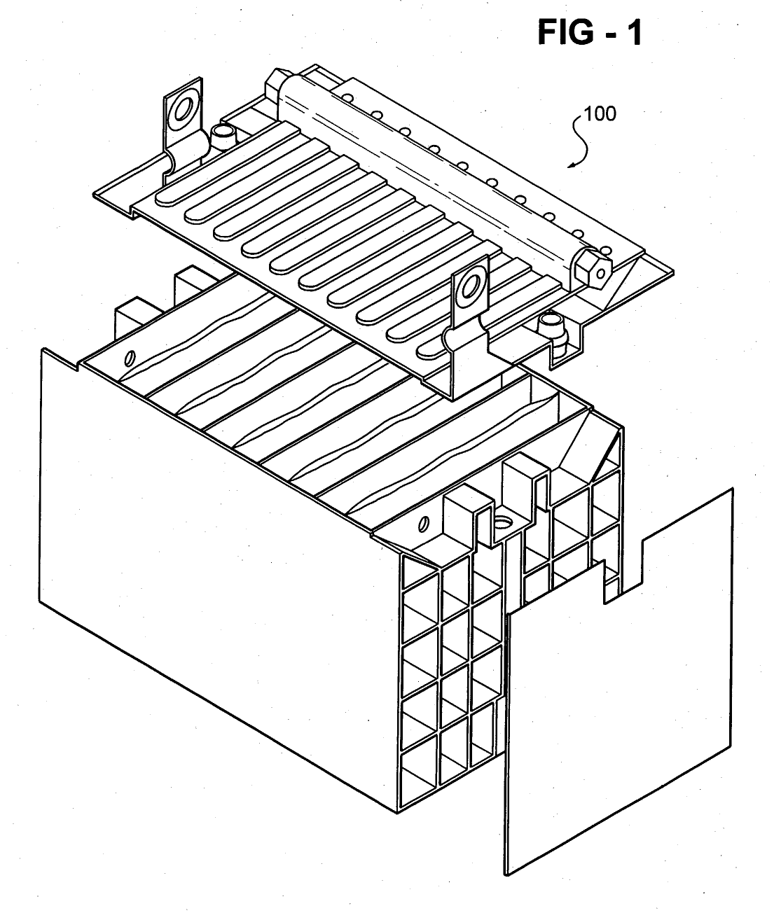

Illustrated in FIG. 1 is a monoblock battery 100 assembly that may use the polymer alloy of the present invention. The monoblock battery of FIG. 1 is disclosed in U.S. Pat. No. 6,255,015 issued on Jul. 3, 2001 to Corrigan et al., which is hereby incorporated herein by reference. However, it should be apparent that any battery casing that requires a construction material with the properties of the novel polymer alloy disclosed herein might be utilized. Further, the battery depicted in FIG. 1 should not be considered limiting.

The embodiments of the invention disclosed heretofore may be used with any battery that requires a casing with the attributes as detailed above. While the invention has been illustrated in detail in the drawings and the foregoing description, the same is to be considered as illustrative and not restrictive in character as the present invention and the concepts herein may be applied to any battery that utilizes a plastic casing. It will be apparent to those skilled in the art that variations and modifications of the present invention can be made without departing from the scope or spirit of the invention.

We claim:

1. A polymer alloy comprising:
about 30 to 45 weight % polyphenylene ether;
about 30 to 45 weight % polystyrene; and
about 10 to 40 weight % glass fibers.

2. The polymer alloy of claim 1, said polymer alloy comprising a 1 to 1 ratio of polyphenylene ether to polystyrene.

3. The polymer alloy of claim 1, said polystyrene comprising high impact polystyrene.

4. The polymer alloy of claim 1, further comprising 0 to 15 weight % of an elastomer.

5. The polymer alloy of claim 4, said elastomer selected from the group consisting of styrene-butadiene rubber, butadiene rubber and ethylene-propylene terpolymer.

6. The polymer alloy of claim 1, said glass fibers having a diameter of from 3.75×10⁻⁴ inches to 1.00×10⁻³ inches.

7. A sealed alkaline storage battery comprising a cell in which power generating elements and an alkaline electrolyte are accommodated in a battery casing of a synthetic resin, said casing comprising a polymer alloy, said polymer alloy comprising:
about 30 to 45 weight % polyphenylene ether;
about 30 to 45 weight % polystyrene; and
about 10 to 40 weight % glass fibers.

8. The sealed alkaline storage battery of claim 7, said polymer alloy comprising a 1 to 1 ratio of polyphenylene ether to polystyrene.

9. The sealed alkaline storage battery of claim 7, said polystyrene comprising high impact polystyrene.

10. The sealed alkaline storage battery of claim 7, further comprising 0 to 15 weight % of an elastomer.

11. The sealed alkaline storage battery of claim 10, said elastomer selected from the group consisting of styrene-butadiene rubber, butadiene rubber and ethylene-propylene terpolymer.

12. The sealed alkaline storage battery of claim 7, said glass fibers having a diameter of from 3.75×10⁻⁴ inches to 1.00×10⁻³ inches.

13. A sealed alkaline storage battery comprising a cell in which power generating elements and an alkaline electrolyte are accommodated in a battery casing of a synthetic resin, wherein said casing is a polymer alloy which comprises:
polyphenylene ether;
polystyrene; and
glass fibers.

14. The sealed alkaline storage battery of claim 13, said polymer alloy comprising a 1 to 1 ratio of polyphenylene ether to polystyrene.

15. The sealed alkaline storage battery of claim 13, said polystyrene comprising high impact polystyrene.

16. The sealed alkaline storage battery of claim 13, further comprising 0 to 15 weight % of an elastomer.

17. The sealed alkaline storage battery of claim 16, said elastomer selected from the group consisting of styrene-butadiene rubber, butadiene rubber and ethylene-propylene terpolymer.

18. The sealed alkaline storage battery of claim 13, said glass fibers having a diameter of from 3.75×10⁻⁴ inches to 1.00×10⁻³ inches.

19. The sealed alkaline storage battery of claim 13, said polymer alloy comprising:
about 30 to 45 weight % polyphenylene ether;
about 30 to 45 weight % polystyrene; and
about 10 to 40 weight % glass fibers.

20. The sealed alkaline storage battery of claim 13, said polymer alloy comprising a 1 to 1 ratio of polyphenylene ether to polystyrene.
